(19) United States
(12) Patent Application Publication
(10) Pub. No.: US 2024/0340831 A1
(43) Pub. Date: Oct. 10, 2024

(54) METHODS AND APPARATUSES FOR SYNCHRONISING DATA AT A NETWORK AND FUNCTION

(71) Applicant: Telefonaktiebolaget LM Ericsson (publ), Stockholm (SE)

(72) Inventors: Maria Cruz BARTOLOME RODRIGO, Madrid (ES); Emiliano MERINO VAZQUEZ, Madrid (ES)

(21) Appl. No.: 18/293,554

(22) PCT Filed: Jul. 28, 2022
(86) PCT No.: PCT/EP2022/071234

§ 371 Date: Jan. 30, 2024

(30) Foreign Application Priority Data
Aug. 6, 2021 (EP) 21382745.4

(51) Int. Cl. H04W 60/00

(52) U.S. Cl. CPC H04W 60/00

(57) ABSTRACT

Embodiments described herein relate to methods and apparatuses for synchronizing data at a second network function. A method in a first network function includes: receiving, from the second network function, an indication of potential registration data inconsistency associated with one or more wireless devices; receiving a registration request for a first wireless device from a third network function, wherein the registration request includes a first indication indicating that a reason for the registration request is potential data inconsistency; and responsive to receiving the registration request, updating the registration data at the second network function.

### TECHNICAL FIELD

Embodiments described herein relate to methods and apparatuses for synchronizing data at a second network function, for example a Unified Data Repository.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In a core network (for example, a 5G core network implemented as a service based architecture), there may be some scenarios in which data in a unified data repository, UDR is partially or totally lost, or where the data has to be retrieved from a previous backup. In these scenarios, the data at the UDR may not be fully consistent with the data that is being stored and/or used by the Network Function consumers of this data (for example, Network Exposure Functions (NEFs), Session Management Functions (SMFs), Policy Charging and Control Functions (PCFs), and Access and Mobility Management Functions (AMFs) etc.)

Different solutions are currently being proposed to allow the NF consumers to regenerate and/or restore that data again, when possible, in order to bring back consistency across the consumer NFs and the UDR.

### SUMMARY

According to some embodiments there is provided a method in a first network function for synchronizing data at a second network function. The method comprises receiving, from a second network function, an indication of potential registration data inconsistency associated with one or more wireless devices; receiving a registration request for a first wireless device from a third network function, wherein the registration request comprises a first indication indicating that a reason for the registration request is potential data inconsistency; and responsive to receiving the registration request, updating the registration data at the second network function.

According to some embodiments there is provided a method in a third network function for synchronizing data at a second network function. The method comprises receiving, from a first network function, a notification of a potential registration data inconsistency for one or more wireless devices; and responsive to receiving a registration update from a first wireless device of the one or more wireless devices, transmitting a registration request for a first wireless device to the first network function; wherein the registration request comprises a first indication indicating that a reason for the registration request is potential registration data inconsistency.

According to some embodiments there is provided a method in a fourth network function for synchronizing data at a second network function. The method comprises receiving, a notification of a potential registration data inconsistency for one or more wireless devices.

According to some embodiments there is provided a method in a second network function for synchronizing data at the second network function. The method comprise obtaining an indication of one or more first network functions from a fifth network function; wherein the one or more first network functions are associated with a potential inconsistent registration data notification type in the fifth network function.

According to some embodiments there is provided a first network function for synchronizing data at a second network function. The first network function comprises processing circuitry configured to cause the first network function to: receive, from a second network function, an indication of potential registration data inconsistency associated with one or more wireless devices.

According to some embodiments there is provided a third network function for synchronizing data at a second network function. The third network function comprises processing circuitry configured to cause the third network function to: receive, from a first network function, a notification of a potential registration data inconsistency for one or more wireless devices.

According to some embodiments there is provided a fourth network function for synchronizing data at a second network function. The fourth network function comprises processing circuitry configured to cause the fourth network function to: receive, a notification of a potential registration data inconsistency for one or more wireless devices.

According to some embodiments there is provided a second network function for synchronizing data at the second network function. The second network function comprises processing circuitry configured to cause the second network function to: obtain an indication of one or more first network functions from a fifth network function; wherein the one or more first network functions are associated with a potential inconsistent registration data notification type in the fifth network function.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a method in a first network function for synchronising data at a second network function;

FIG. 2 illustrates a method in a third network function for synchronising data at a second network function;

FIG. 3 illustrates a method in a fourth network function for synchronising data at a second network function;

FIG. 4 illustrates a method in a second network function for synchronising data at a second network function;

FIGS. 5 (a), 5 (b) and 5 (c) illustrate an example implementation of the methods of FIGS. 1 to 4.

FIG. 6 illustrates a first network function comprising processing circuitry (or logic);

FIG. 7 illustrates a third network function comprising processing circuitry (or logic);

FIG. 8 illustrates a fourth network function comprising processing circuitry (or logic);

FIG. 9 illustrates a second network function comprising processing circuitry (or logic);

FIG. 10 illustrates a networked system in accordance with particular embodiments of the solution described herein.

### DESCRIPTION

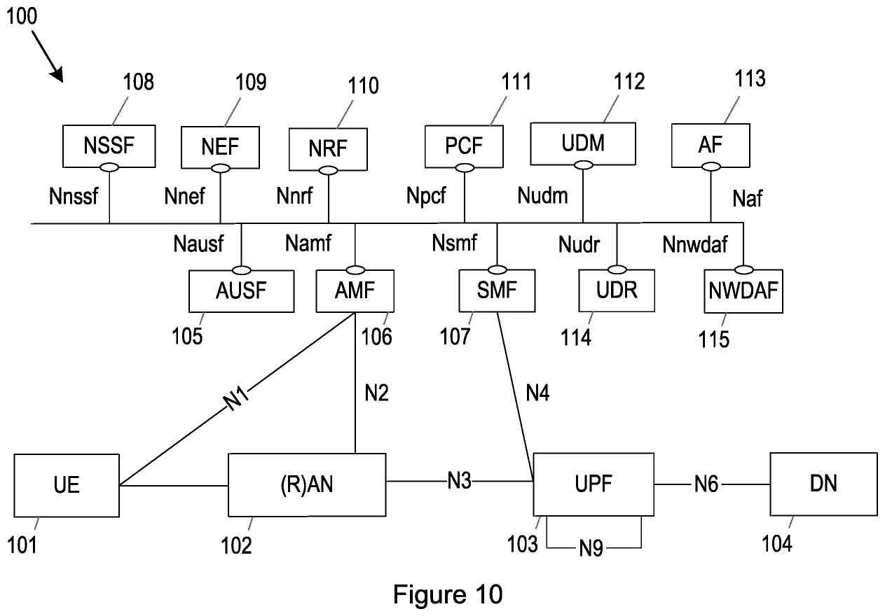

The example embodiments described herein arise in the context of a telecommunications network, also referred to as communications network in this disclosure, including but not limited to a telecommunications network that conforms to and/or otherwise incorporates aspects of a fifth generation (5G) architecture. FIG. 10 is an example networked system 100 in accordance with example embodiments of the present disclosure. FIG. 10 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110, User Data Repository (UDR) 114, Network Data Analytics Function (NWDAF) 115 and Data Network (DN) 104. In some example implementations of embodiments of the present disclosure, an AMF 106, SMF 107, UPF 103, PCF 111, AUSF 105, NRF 110, UDM 112, NEF 109, AF 113, UDR 114, NWDAF 115, and NSSF 108 are each considered to be an NF. One or more additional instances of the network functions (NF) may be incorporated into the networked system.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Currently, there are no solutions for the problems stated above.

For example, if registration data for a particular wireless device stored in a UDR is lost, then it may be useful for an AMF to perform a new registration associated with the wireless device with the UDM, and as a result, the registration data for the wireless device will be restored and/or updated in UDR, and made consistent with the actual registration context of the wireless device.

Some embodiments described herein focus on the issues relating to the NEF(s) (which, it will be appreciated, are also applicable the Service Capability Exposure Function (SCEF) in 4G). Currently, an NEF is not provided with any information nor indication of when some data may be corrupted or inconsistent at a UDR, and that therefore the UDR data may need to be re-generated (if possible).

If, for example, an NEF were to receive an indication, by any means, that there is “Potential UDR Data Inconsistency”, it may then start re-generating any relevant data. For example, the NEF may subscribe to be notified to some changes and/or updates in a wireless device's state or events. Then, if the UDR data is inconsistent (i.e. the NEF internal data is not the same than the data stored in UDR), then the NEF may transmit those subscriptions again to the UDM (for use in updating the UDR).

However, in examples in which the potential data inconsistency affects a large number of wireless devices (e.g. in massive IoT deployments), this would mean that the NEF may need to send a huge number of subscriptions with no criteria other than a time window and burst size to the UDM, so it might overload the UDM and as a consequence the UDR as well, causing a lot of rejections in restoration/re-generation attempts.

In order to avoid this excessive signalling and request bursts, there are mechanisms that may be implemented in the NEF in order to pace the transmitted subscriptions to the UDM. For example, the NEF may react upon error codes by the UDM, or load and overload control mechanisms may need to be implemented in order to pace requests and dynamically adapt the requests throughput.

Although this is possible, this requires an important implementation cost as well as processing cost, even more so when the adaptation may differ depending on the UDM/UDR vendor. For example, whether or not the NEF may implement load/overload mechanisms may not be consistent across UDMs. Even the usage of error codes may not be fully consistent across UDMs.

Furthermore, these pacing mechanisms may not be able to guarantee that rejections to restore data will not occur. Moreover, these pacing mechanisms do not provide any indication to operators as to what percentage or number of wireless devices have been restored at a given point in time.

Some embodiments described herein therefore also provide methods and apparatuses that enable an NEF/SCEF to effectively receive an indication (e.g. via the UDM) of UE activity. The NEF may then utilize this indication restore any required data in UDR.

Some embodiments described herein also enable the UDM to keep track of the progress of re-synchronization of data in UDR, after having received a warning of a “Potential UDR Data Inconsistency”. For example, by keeping track of the number of wireless devices for whom the data has been restored. An operator may therefore easily check (for example, via O&M node) the number of wireless devices whose data is already consistent across the network, and may therefore be able to estimate the percentage of wireless device that are remaining unsynchronized, so that they can decide to accelerate or keep the same progress via other O&M initiated means.

Some embodiments described herein avoid the need to implement in the NEF/SCEF message throughput adaptation mechanisms towards different UDM/UDR vendors (e.g. as described above). Instead, by providing the NEF/SCEF with an effective indication of UE activity, re-generation and/or restoration of the wireless devices data in the UDR may be performed in a smooth and gradual manner, related to (or effectively controlled by) the naturally occurring traffic from the wireless device.

Embodiments described herein are described with reference to network functions in the 5G core network. It will however be appreciated that the functionality described as being performed by a 5G core network function may equivalently be performed by a network node or function in another type of network, e.g. a 4G core network. For example, the functionality described as being performed by an NEF may be equivalently performed by the SCEF in a 4G network.

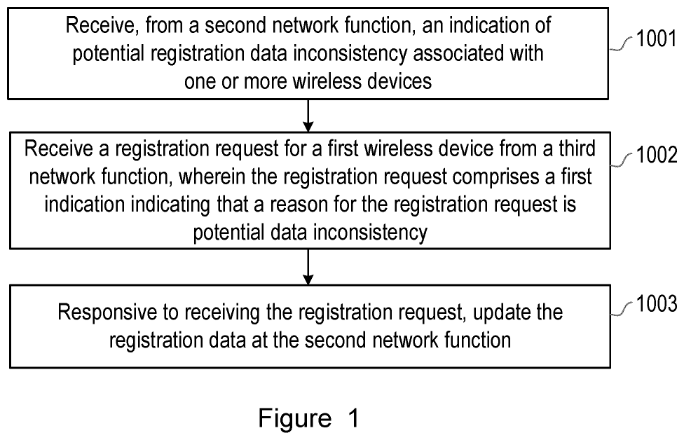

FIG. 1 illustrates a method in a first network function for synchronising data at a second network function. The method comprises in step 1001 receiving, from a second network function, an indication of potential registration data inconsistency associated with one or more wireless devices. In step 1002 the method may comprise receiving a registration request for a first wireless device from a third network function, wherein the registration request comprises a first indication indicating that a reason for the registration request is potential data inconsistency. In step 1003, the method may comprise responsive to receiving the registration request, updating the registration data at the second network function. The first network function may comprise a Unified Data Management, UDM, function. The second network function may comprise a Unified Data Repository, UDR, function.

The method of FIG. 1 may be performed by a first network function, which may comprise a physical or virtual node, and may be implemented in a computing device or server apparatus and/or in a virtualized environment, for example in a cloud, edge cloud or fog deployment.

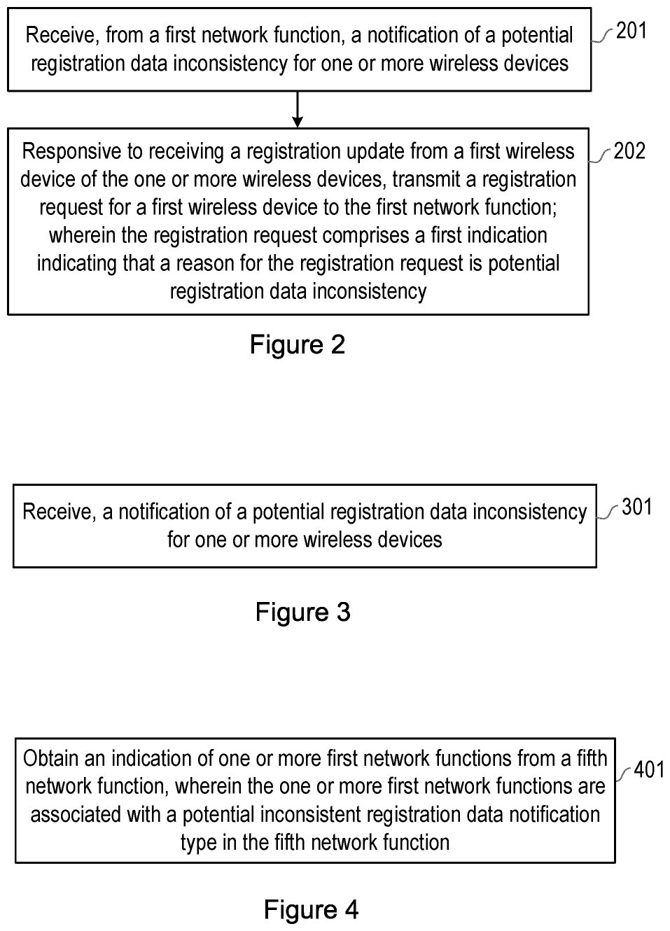

FIG. 2 illustrates a method in a third network function for synchronizing data at a second network function. The method comprises in step 201 receiving, from a first network function, a notification of a potential registration data inconsistency for one or more wireless devices. In step 202 the method may comprise responsive to receiving a registration update from a first wireless device of the one or more wireless devices, transmitting a registration request for a first wireless device to the first network function; wherein the registration request comprises a first indication indicating that a reason for the registration request is potential registration data inconsistency. The third network function may comprise an Access and Mobility Management Function, AMF. The first network function may comprise the first network function configured to perform the method of FIG. 1.

The method of FIG. 2 may be performed by a third network function, which may comprise a physical or virtual node, and may be implemented in a computing device or server apparatus and/or in a virtualized environment, for example in a cloud, edge cloud or fog deployment.

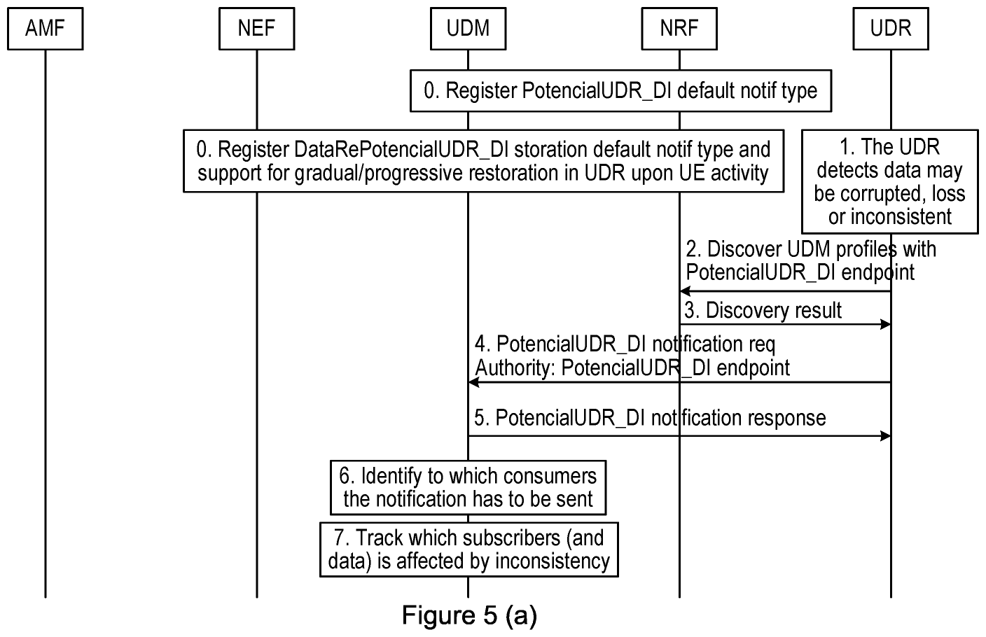

FIG. 3 illustrates a method in a fourth network function for synchronizing data at a second network function. The method comprises in step 301 receiving, a notification of a potential registration data inconsistency for one or more wireless devices. The fourth network function may comprise a NEF.

The method of FIG. 3 may be performed by a fourth network function, which may comprise a physical or virtual node, and may be implemented in a computing device or server apparatus and/or in a virtualized environment, for example in a cloud, edge cloud or fog deployment.

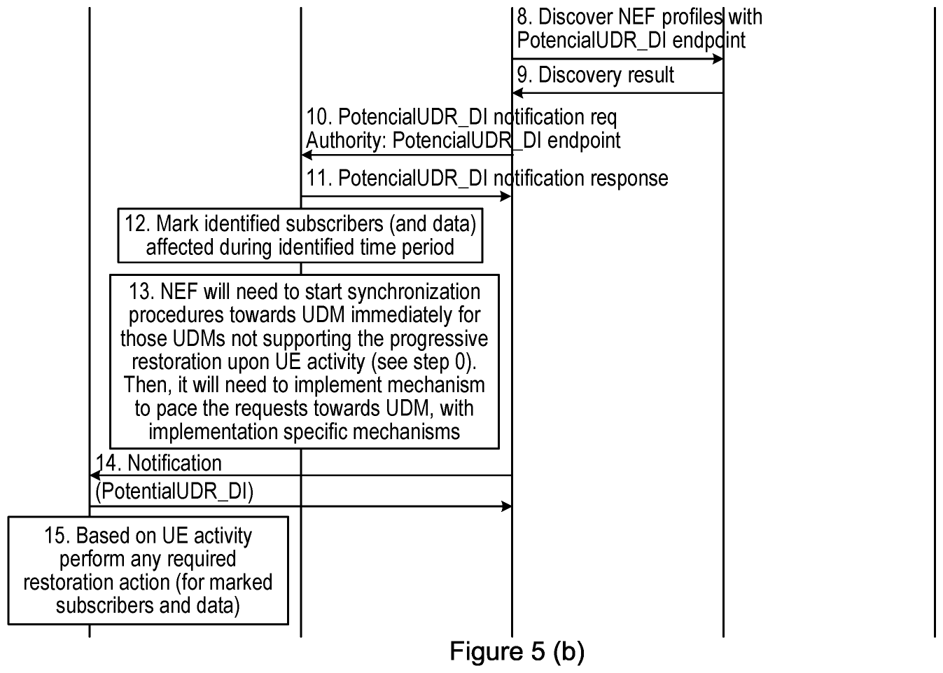

FIG. 4 illustrates a method in a second network function for synchronizing data at the second network function. The method comprises in step 401 obtaining an indication of one or more first network functions from a fifth network function; wherein the one or more first network functions are associated with a potential inconsistent registration data notification type in the fifth network function. The second network function may comprise a UDR. The one or more first network functions may comprise UDM network functions. The fifth network function may comprise a Network Repository Function, NRF.

The method of FIG. 4 may be performed by a fourth network function, which may comprise a physical or virtual node, and may be implemented in a computing device or server apparatus and/or in a virtualized environment, for example in a cloud, edge cloud or fog deployment.

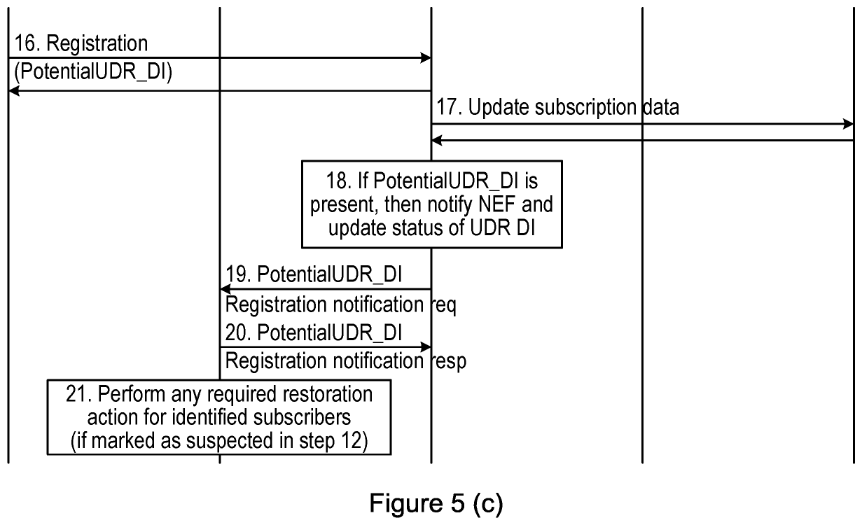

FIGS. 5 (a), 5 (b) and 5 (c) illustrate an example implementation of the methods of FIGS. 1 to 4. The method of FIGS. 5 (a), 5 (b) and 5 (c) is illustrated as being performed by an AMF, an NEF, a UDM an NRF and a UDR. It will be appreciated that the functions described as being performed by these network functions may equivalently be performed by a generic network functions in a different network type.

In step 0, the UDM and the NEF both register, at the NRF, that they are configured to receive potential inconsistent registration data notifications. In other words, the UDM and the NEF both register, in their profile at the NRF, that they are a “PotentialUDRDatalnconsistency” (PotentialUDR_DI) default notification endpoint.

The NEF and UDM, in this example, also register that they support restoration of data upon wireless device activity.

In step 1, the UDR detected that data may be corrupted, lost or inconsistent. For example, the UDR may fail and restart, or migration of data from am old UDR to new UDR may occur.

In step 2, the UDR, performs the step of obtaining (e.g. step 401 of FIG. 4) an indication of one or more UDMs. This step may be performed responsive to detecting a potential registration data inconsistency associated with one or more wireless devices (e.g. responsive to step 1).

The UDR may in some examples, perform the step of obtaining an indication of one or more UDMs by transmitting a first discovery request to the NRF, wherein the first discovery request indicates that network functions of the type UDM are the object of the discovery request; receiving one or more network function profiles for UDMs from the NRF; and selecting the one or more UDMs as the one or more UDMs that have the potential inconsistent registration data notification type in the one or more network function profiles for UDMs. In other words, the UDR may discover all the profiles for a certain (network function type) NFtype (e.g. UDM) and then search within the profiles returned by NRF for the ones which include PotentialUDRDatalnconsistency notification type.

Alternatively, as illustrated in FIGS. 5 (a), 5 (b) and 5 (c), the UDR may perform the step of obtaining an indication of one or more UDMs by: transmitting (e.g. step 2) a first discovery request to the NRF, wherein the first discovery request indicates the network function type UDM and the potential inconsistent registration data notification type (e.g. PotentialUDR_DI); and receiving (step 3), from the NRF, one or more network function profiles for UDMs for the one or more UDMs. In other words, the UDR may use the notification-type (set to PotentialUDRDatalnconsistency) as a discovery query parameter, so that the NRF only returns the NF profiles which comprise the PotentialUDRDatalnconsistency default notification type.

In step 4, the UDR transmits, to the one or more UDMs (e.g. those obtained by performed steps 2 and 3, where only one UDM is illustrated in FIGS. 5 (a), 5 (b) and 5 (c), an indication of the potential registration data inconsistency for the one or more wireless devices. This indication may indicate which one or more wireless devices may be affected by the potential registration data inconsistency. This indication may also comprise a time period for which the potential registration data inconsistency may be valid.

In some examples, the UDR will repeat steps 2 to 4 for the NFtype NEF in order to also notify the relevant NEFs of the potential data inconsistency. However, in the example illustrated in FIGS. 5 (a), 5 (b) and 5 (c), the notification of the NEFs is performed by the UDM (as will be described with reference to steps 8 to 10) In step 5, the UDM acknowledges the message sent in step 4.

In step 6, the UDM identifies which consumer NFs to which the UDM should forward the notification received in step 4. For example, based on the impacted users and respective impacted data, as well as the time period the data inconsistency may affect, the UDM may determine that exposure data is potentially also inconsistent at the UDR. The UDM may then determine that NEF instances need to be informed.

The UDM may also determine one or more AMFs that are to be informed of the potential data inconsistency.

In some examples, in step 7, the UDM may track which wireless devices (and, optionally, data) are affected by the UDR Data Inconsistency (for example by storing this information at the UDR). In some examples, the UDM may record a count of the one or more wireless devices. For example, the UDM may count a wireless device in the one or more wireless devices as “registration data inconsistent” in KPIs/counters that are accessible at any time by an operator via O&M.

In step 8, the UDM discovers one or more NEFs. In particular, the UDM discovers one or more NEFs that include PotentialUDRDatalnconsistency notification type in their profiles. Steps 8 and 9 may be performed similarly to as described for steps 2 and 3.

In step 10, the UDM transmits the PotentialUDRDatalnconsistency notification to the one or more NEFs (only one illustrated) discovered in steps 8 and 9. In other words, the UDM notifies the one or more NEFs of the potential registration data inconsistency for the one or more wireless devices. The content of this message (step 10) may be the same as the content of message received at the UDM in step 4.

As previously described, it will be appreciated that steps 8, 9 and 10 may be instead performed by the UDR.

In step 11, the NEF acknowledges the message received in step 10.

If a UDR Group Identification (UDRGroupId) was received from UDR, the UDM may need to map that onto corresponding UDM Group Identification UDMGroupId(s) if applicable, how this is done is implementation specific. A group ID in UDR identifies a set of users being served by UDR, e.g. the group id can be “UDR-group-1”. When UDM is receiving this information as part of the notification, it needs to know which UDM group id (which identifies the set of users) is related to. This may be performed by mapping “UDR-group-1” to “UDM-group-1”, for example.

In step 12, the NEF may record the one or more wireless devices that may be impacted by the potential registration data inconsistency. For example, the NEF may mark the one or more wireless devices as “pending restoration of exposure data”. The NEF may also record a time interval if one was noted by the UDR.

In step 13, the NEF may start synchronisation procedures without any further initiation for those UDMs not supporting the progressive restoration of data upon wireless device activity. In other words, responsive to the UDM not having previously indicated support of restoration of data upon wireless device activity (however, in the example illustrated in FIGS. 5 (a), 5 (b) and 5 (c), at step 0 the UDM did indicate support of restoration of data), the NEF may start a synchronization procedure towards the UDR. It will be appreciated that mechanisms may be used in order to pace the requests to the UDR appropriately (as previously described). An NEF which itself does not support progressive restoration of data upon wireless device activity may also start synchronization procedures at this stage.

However, in this example, the UDM did indicate support of restoration of data upon wireless device activity at step 0. Therefore, in this example, the NEF (which in this example does support progressive restoration of data upon wireless device activity as noted in step 0) instead waits to receive indication of wireless device activity before proceeding with any synchronization.

In step 14, the UDM notifies the AMF of the potential registration data inconsistency for the one or more wireless devices. This step may be performed as a broadcast to all AMFs. Alternatively, the UDM may transmit the notification only to AMFs currently serving a wireless device or currently serving one of the one or more wireless devices. The UDM may have a list stored/cached which includes all AMFs which have at least served a wireless device, so it may not need to discover these AMFs. However, in some examples, the AMFs may be discovered from the NRF.

This notification of step 14 may comprise the information received from the UDR in step 4.

The AMF may record any wireless devices that it is serving that fall within the one or more wireless devices in the notification from the UDM. For example, the AMF may mark such wireless devices as “pending restoration of registration data”.

In step 15, the AMF, based on the activity of wireless devices, performs any required restoration action for those wireless devices marked as “pending restoration of registration data”. The AMF periodically receives wireless device activity (e.g. the wireless devices the AMF is serving periodically send a “registration update” to the AMF to inform the network that it is reachable for terminating calls and/or downlink data and/or paging). The AMF is the only NF which is periodically receiving this keepalive from the wireless device. For example, the NEF does not receive this information in a periodic manner. If the restoration of a wireless device's data is to be done progressively, instead of being initiated by NEF (causing massive signaling), the methods describe herein ensure that upon a periodic wireless device's contact to the AMF, the NEF is notified about traffic activity from the wireless device, and may then initiate the restoration for that wireless device. This is a gradual procedure executed as and when wireless devices contact the network, not before.

For example, in step 16 the AMF, responsive to receiving a registration update from a first wireless device of the one or more wireless devices, transmits a registration request for the first wireless device to the UDM, wherein the registration request comprises an indication indicating that a reason for the registration request is potential registration data inconsistency. The AMF may then record that the first wireless device's registration data is no longer pending to be restored. This may prevent any further restoration actions following any further communication from the wireless device.

In step 17, the UDM updates/restores the registration data in the UDR based on the registration update received in step 16.

In step 18, the UDM, responsive to the registration request comprising the indication indicating that the reason for the registration request is potential data inconsistency (e.g. the flag PotentialUDR_DI), notifies at least one of the one or more NEFs of the registration request for the first wireless device, wherein the at least one of the one or more NEFs previously indicated support of restoration of data upon wireless device activity. In this example therefore (in step 19), the UDM indicates the “Potential UDR_DI” flag to the NEF, whilst notifying that a registration request has been received from the AMF. This indication allows for the solving of the data inconsistency between the NEF and the UDR.

For example, the UDM may discover the NEFs that support restoration of data upon wireless device activity from the NRF.

In step 20, the NEF acknowledges the message received in step 19.

In step 21, the NEF performs any required restoration actions for the one or more wireless devices. For example, the NEF may transmit a subscription request for the first wireless device to the UDM; and responsive to the subscription request comprising a second indication indicating that subscription request is intended to restore data at the UDR, the UDM may record that the first wireless device exposure data has been restored. The UDM may also pass on the subscription request to the UDR to update the exposure data at the UDR. Once restoration actions have been performed for a wireless device, the NEF may mark the wireless device as “exposure data restored”.

In other words, the notification received the NEF in step 19 may be interpreted as user activity which might have potential inconsistency. The NEF may then perform any required restoration actions (e.g. transmitting a corresponding subscription request to UDM). The NEF may also include an indication that the subscription to be restored is intended to serve as re-generation/restoration of UDR data; e.g. it is not initiated by an AF (Application Function), but solely initiated by NEF. Based on this indication, the UDM may count the user as having its “exposure data restored” in KPIs/counters to be accessible at any time by operator via O&M.

Exposure data may comprise subscriptions to notifications about certain network events. For example, an NEF may subscribe to International Mobile Equipment Identity (IMEI) changes for a given wireless device (e.g. to be notified when the wireless device changes smartphone, e.g. introducing the SIM card in a new smartphone). This subscription to notifications about IMEI changes is sent to the UDM, and UDM stores this in the UDR. If the UDR loses this data, the NEF won't be notified about IMEI changes anymore. By implementing the method as described above, if the NEF receives a notification from the UDM about UDR inconsistency (which will make NEF mark the affected users) and after that the NEF receives a notification from the UDM about wireless device traffic activity detected (sent by the AMF to the UDM since the AMF also had the wireless devices marked as “pending to be restored”), the NEF will check if the wireless device is marked as “pending to be restored” (similar to as done by the AMF). If the wireless device is marked as “pending to be restored”, the NEF may then re-send the subscription request for the IMEI change event, so that it is restored in the UDR and the UDM may then notify about the NEF about IMEI changes as usual.

In this way, the AMF contacting the UDM served as a trigger to the NEF to also restore the user for the exposure data (which may for example include the subscription to notifications about event exposure).

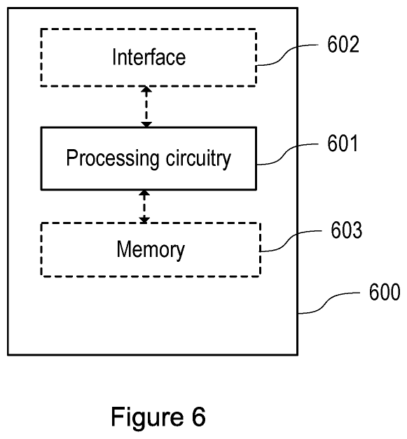

FIG. 6 illustrates a first network function 600 comprising processing circuitry (or logic) 601. The processing circuitry 601 controls the operation of the first network function 600 and can implement the method described herein in relation to a first network function 600. The processing circuitry 601 can comprise one or more processors, processing units, multi-core processors or modules that are configured or programmed to control the first network function 600 in the manner described herein. In particular implementations, the processing circuitry 601 can comprise a plurality of software and/or hardware modules that are each configured to perform, or are for performing, individual or multiple steps of the method described herein in relation to the first network function 600.

Briefly, the processing circuitry 601 of the first network function 600 is configured to: receive, from a second network function, an indication of potential registration data inconsistency associated with one or more wireless devices. The processing circuitry may be further configured to receive a registration request for a first wireless device from a third network function, wherein the registration request comprises a first indication indicating that a reason for the registration request is potential data inconsistency; and responsive to receiving the registration request, update the registration data at the second network function.

In some embodiments, the first network function 600 may optionally comprise a communications interface 602. The communications interface 602 of the first network function 600 can be for use in communicating with other nodes, such as other virtual nodes. For example, the communications interface 602 of the first network function 600 can be configured to transmit to and/or receive from other nodes requests, resources, information, data, signals, or similar. The processing circuitry 601 of first network function 600 may be configured to control the communications interface 602 of the first network function 600 to transmit to and/or receive from other nodes requests, resources, information, data, signals, or similar.

Optionally, the first network function 600 may comprise a memory 603. In some embodiments, the memory 603 of the first network function 600 can be configured to store program code that can be executed by the processing circuitry 601 of the first network function 600 to perform the method described herein in relation to the first network function 600. Alternatively or in addition, the memory 603 of the first network function 600, can be configured to store any requests, resources, information, data, signals, or similar that are described herein. The processing circuitry 601 of the first network function 600 may be configured to control the memory 603 of the first network function 600 to store any requests, resources, information, data, signals, or similar that are described herein.

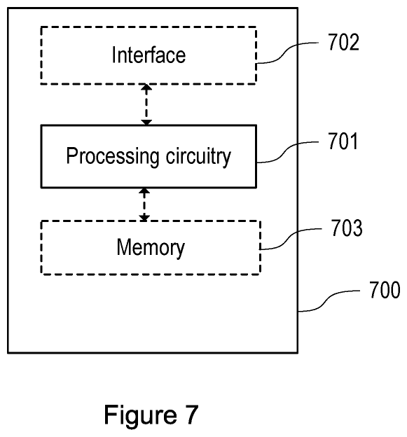

FIG. 7 illustrates a third network function 700 comprising processing circuitry (or logic) 701. The processing circuitry 701 controls the operation of the third network function 700 and can implement the method described herein in relation to a third network function 700. The processing circuitry 701 can comprise one or more processors, processing units, multi-core processors or modules that are configured or programmed to control the third network function 700 in the manner described herein. In particular implementations, the processing circuitry 701 can comprise a plurality of software and/or hardware modules that are each configured to perform, or are for performing, individual or multiple steps of the method described herein in relation to the third network function 700.

Briefly, the processing circuitry 701 of the third network function 700 is configured to: receive, from a first network function, a notification of a potential registration data inconsistency for one or more wireless devices. The processing circuitry 701 may be further configured to responsive to receiving a registration update from a first wireless device of the one or more wireless devices, transmit a registration request for a first wireless device to the first network function; wherein the registration request comprises a first indication indicating that a reason for the registration request is potential registration data inconsistency.

In some embodiments, the third network function 700 may optionally comprise a communications interface 702. The communications interface 702 of the third network function 700 can be for use in communicating with other nodes, such as other virtual nodes. For example, the communications interface 702 of the third network function 700 can be configured to transmit to and/or receive from other nodes requests, resources, information, data, signals, or similar. The processing circuitry 701 of third network function 700 may be configured to control the communications interface 702 of the third network function 700 to transmit to and/or receive from other nodes requests, resources, information, data, signals, or similar.

Optionally, the third network function 700 may comprise a memory 703. In some embodiments, the memory 703 of the third network function 700 can be configured to store program code that can be executed by the processing circuitry 701 of the third network function 700 to perform the method described herein in relation to the third network function 700. Alternatively or in addition, the memory 703 of the third network function 700, can be configured to store any requests, resources, information, data, signals, or similar that are described herein. The processing circuitry 701 of the third network function 700 may be configured to control the memory 703 of the third network function 700 to store any requests, resources, information, data, signals, or similar that are described herein.

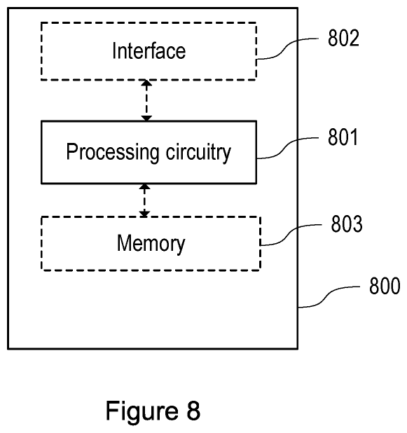

FIG. 8 illustrates a fourth network function 800 comprising processing circuitry (or logic) 801. The processing circuitry 801 controls the operation of the fourth network function 800 and can implement the method described herein in relation to a fourth network function 800. The processing circuitry 801 can comprise one or more processors, processing units, multi-core processors or modules that are configured or programmed to control the fourth network function 800 in the manner described herein. In particular implementations, the processing circuitry 801 can comprise a plurality of software and/or hardware modules that are each configured to perform, or are for performing, individual or multiple steps of the method described herein in relation to the fourth network function 800.

Briefly, the processing circuitry 801 of the fourth network function 800 is configured to: receive, a notification of a potential registration data inconsistency for one or more wireless devices.

In some embodiments, the fourth network function 800 may optionally comprise a communications interface 802. The communications interface 802 of the fourth network function 800 can be for use in communicating with other nodes, such as other virtual nodes. For example, the communications interface 802 of the fourth network function 800 can be configured to transmit to and/or receive from other nodes requests, resources, information, data, signals, or similar. The processing circuitry 801 of fourth network function 800 may be configured to control the communications interface 802 of the fourth network function 800 to transmit to and/or receive from other nodes requests, resources, information, data, signals, or similar.

Optionally, the fourth network function 800 may comprise a memory 803. In some embodiments, the memory 803 of the fourth network function 800 can be configured to store program code that can be executed by the processing circuitry 801 of the fourth network function 800 to perform the method described herein in relation to the fourth network function 800. Alternatively or in addition, the memory 803 of the fourth network function 800, can be configured to store any requests, resources, information, data, signals, or similar that are described herein. The processing circuitry 801 of the fourth network function 800 may be configured to control the memory 803 of the fourth network function 800 to store any requests, resources, information, data, signals, or similar that are described herein.

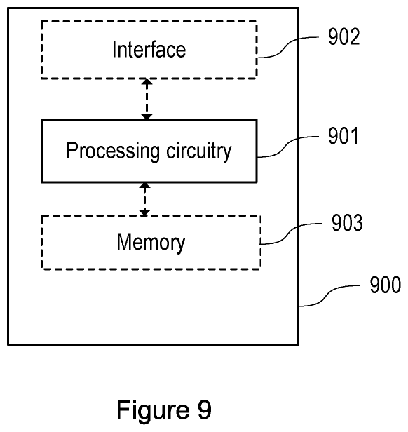

FIG. 9 illustrates a second network function 900 comprising processing circuitry (or logic) 901. The processing circuitry 901 controls the operation of the second network function 900 and can implement the method described herein in relation to a second network function 900. The processing circuitry 901 can comprise one or more processors, processing units, multi-core processors or modules that are configured or programmed to control the second network function 900 in the manner described herein. In particular implementations, the processing circuitry 901 can comprise a plurality of software and/or hardware modules that are each configured to perform, or are for performing, individual or multiple steps of the method described herein in relation to the second network function 900.

Briefly, the processing circuitry 901 of the second network function 900 is configured to: obtain an indication of one or more first network functions from a fifth network function; wherein the one or more first network functions are associated with a potential inconsistent registration data notification type in the fifth network function.

In some embodiments, the second network function 900 may optionally comprise a communications interface 902. The communications interface 902 of the second network function 900 can be for use in communicating with other nodes, such as other virtual nodes. For example, the communications interface 902 of the second network function 900 can be configured to transmit to and/or receive from other nodes requests, resources, information, data, signals, or similar. The processing circuitry 901 of second network function 900 may be configured to control the communications interface 902 of the second network function 900 to transmit to and/or receive from other nodes requests, resources, information, data, signals, or similar.

Optionally, the second network function 900 may comprise a memory 903. In some embodiments, the memory 903 of the second network function 900 can be configured to store program code that can be executed by the processing circuitry 901 of the second network function 900 to perform the method described herein in relation to the second network function 900. Alternatively or in addition, the memory 903 of the second network function 900, can be configured to store any requests, resources, information, data, signals, or similar that are described herein. The processing circuitry 901 of the second network function 900 may be configured to control the memory 903 of the second network function 900 to store any requests, resources, information, data, signals, or similar that are described herein.

There is also provided a computer program comprising instructions which, when executed by processing circuitry (such as the processing circuitry 601, 701, 801 or 901 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Implementing embodiments described herein may result in one or more of the following impacts on services, entities and interfaces:

### UDM:

Define and register new PotentialUDRDatalnconsistency notification endpoint in NF profile.
Receive PotentialUDRDatalnconsistency notification triggering required actions for data synchronization.
Discover PotentialUDRDatalnconsistency notification endpoint and send PotentialUDRDatalnconsistency notification request (and identify to which of its consumers it has to send the notifications).
Check if PotentialUDRDatalnconsistency flag is included in Registration, and if so send new notification (Registration for Potential UDR Data Inconsistency) to the NEF.

### UDR:

Identify affected subscribers, affected Data Set and Data SubSet and affected time period of a potential data inconsistency.
Discover PotentialUDRDatalnconsistency notification endpoint and send PotentialUDRDatalnconsistency notification request (previously identifying to which of its consumers it must send the notifications).

### PCF:

Define and register new PotentialUDRDatalnconsistency notification endpoint in NF profile.
Receive PotentialUDRDatalnconsistency notification triggering required actions for data synchronization.
Perform (implementation specific) restoration actions.

### AMF/SMF/SMSF/NEF:

Define and register new PotentialUDRDatalnconsistency notification endpoint in NF profile.
Receive PotentialUDRDatalnconsistency notification triggering required actions for data synchronization.
Mark identified subscribers (and data) affected during identified time period.

### AMF:

Include PotentialUDRDatalnconsistency flag in Registration when it is required for that reason.

### NEF:

Perform (implementation specific) restoration actions when notification from UDM is received for marked users.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-56. (canceled)

57. A method in a first network function for synchronizing data at a second network function, the method comprising:
receiving, from the second network function, an indication of potential registration data inconsistency associated with one or more wireless devices;
receiving a registration request for a first wireless device from a third network function, wherein the registration request comprises a first indication indicating that a reason for the registration request is potential data inconsistency; and
responsive to receiving the registration request, updating the registration data at the second network function.

58. The method as claimed in claim 57 further comprising:
notifying one or more fourth network functions of the potential registration data inconsistency for the one or more wireless devices.

59. The method as claimed in claim 58 wherein the one or more fourth network functions each comprise a Network Exposure Function.

60. The method as claimed in claim 58 further comprising:
discovering the one or more fourth network functions from a fifth network function, wherein the one or more fourth network functions are registered at the fifth network function as potential registration data inconsistency endpoints.

61. The method as claimed in claim 60 wherein the fifth network function comprises a network repository function, NRF.

62. The method as claimed in claim 57 further comprising:
notifying one or more third network functions of the potential registration data inconsistency for the one or more wireless devices.

63. The method as claimed in claim 62 wherein the one or more third network functions each comprise an Access and Mobility Management Function, AMF.

64. The method as claimed in claim 62 further comprising:
discovering the one or more third network functions from a fifth network function.

65. The method as claimed in claim 57 further comprising registering, at a fifth network function, that the first network function is configured to receive potential inconsistent registration data notifications.

66. The method as claimed in claim 65 wherein the fifth network function comprises a network repository function, NRF, the first network function comprises a unified data management, UDM, and the second network function comprises a unified data repository, UDR.

67. A method in a third network function for synchronizing data at a second network function, the method comprising:
receiving, from a first network function, a notification of a potential registration data inconsistency for one or more wireless devices; and
responsive to receiving a registration update from a first wireless device of the one or more wireless devices, transmitting a registration request for a first wireless device to the first network function; wherein the registration request comprises a first indication indicating that a reason for the registration request is potential registration data inconsistency.

68. The method as claimed in claim 67 wherein the third network function comprises an Access and Mobility Management Function, AMF, and the first network function comprises a unified data management, UDM, function.

69. The method as claimed in claim 67 further comprising:
responsive to receiving the notification from the first network function, recording that the one or more wireless devices have inconsistent registration data.

70. A method in a fourth network function for synchronizing data at a second network function, the method comprising:
registering that the fourth network function is configured to receive potential inconsistent registration data notifications at a fifth network function;
receiving, from a first network function, a notification of a registration request for a first wireless device of the one or more wireless devices;
responsive to receiving the notification of a registration request, transmitting a subscription request for the first wireless device to the first network function, wherein the subscription request comprises a second indication indicating that subscription request is intended to restore data at a second network function;
receiving, a notification of a potential registration data inconsistency for one or more wireless devices.

71. The method as claimed in claim 70 wherein the notification of a potential registration data inconsistency for one or more wireless devices is received from a first network function or a second network function.

72. The method as claimed in claim 71 wherein the first network function comprises a unified data management, UDM, function, the second network function comprises a unified data repository, UDR, function, the fifth network function comprises a network repository function, NRF, and the fourth network function comprises a network exposure function, NEF.

73. A method in a second network function for synchronizing data at the second network function, the method comprising:
obtaining an indication of one or more first network functions from a fifth network function; wherein the one or more first network functions are associated with a potential inconsistent registration data notification type in the fifth network function.

74. The method as claimed in claim 73 wherein the step of obtaining an indication of one or more first network functions comprises:
transmitting a first discovery request to the fifth network function, wherein the first discovery request indicates the type of the first network function;
receiving one or more first network function profiles from the fifth network function; and
selecting the one or more first network functions as the one or more first network functions that have the potential inconsistent registration data notification type in the one or more first network function profiles.

75. The method as claimed in claim 73 further comprising:
transmitting, to the one or more first network functions, an indication of the potential registration data inconsistency for the one or more wireless devices.

76. The method as claimed in claim 73 wherein the second network function comprises a Unified Data Repository, UDR, function.

77. A first network function for synchronizing data at a second network function, the first network function comprising processing circuitry configured to cause the first network function to perform the method as claimed in claim 57.
